(19) United States
(12) Patent Application Publication
(10) Pub. No.: US 2002/0103881 A1
(43) Pub. Date: Aug. 1, 2002

(54) Method and system for integrating applications and mobile networks

(76) Inventors: Francois Granade, San Francisco, CA (US); Simon Waddington, Oakland, CA (US); Steve Roberts, Foster City, CA (US); Raphael Auphan, Foster City, CA (US)

Correspondence Address: Law Office Of Leland Wiesner, 1144 Fife Ave., Palo Alto, CA, 94301, US

(21) Appl. No.: 09/950,416

(22) Filed: Sep. 10, 2001

Related U.S. Application Data
(60) Provisional application No. 60/231,845, filed on Sep. 11, 2000.

(51) Int. Cl. G06F 15/16

(52) U.S. Cl. 709/218

(57) ABSTRACT

A method and system for integrating an application executing on a backend system with a mobile device that communicates over a network with the application. The integration includes retrieving from a storage area a method corresponding to a function in the application on the backend system, invoking the method corresponding to the function in the application and creating an interface to the application on the backend system. Information received from the application corresponds to the information requested by the mobile device. This information from the application is transformed to a format suitable for presentation on a mobile device by a presentation server and assisted by a hierarchical universal device library description of mobile devices and browsers.

### CROSS REFERENCE TO RELATED APPLICATIONS

This application claims priority to Provisional Application Serial No. 60/231,845 filed by ViaFone, Inc. Sep. 11, 2000 entitled “Integrating ViaFone Mobile Application Platforms” and is incorporated by reference herein.

### BACKGROUND OF THE INVENTION

Mobile devices have attracted industry attention as a gateway for people to access enterprise and Internet based applications. In response, a diverse set of businesses are interested in deploying data-enabled and voice-enabled services over mobile device networks. Many device manufacturers have developed different types of mobile devices and corresponding applications with hopes of gaining market share and industry dominance. Unfortunately, the results of these efforts have produced a wide-range of hardware and software solutions resulting in mobile device diversity and many incompatibilities. Without significant consolidation, evolution of these technologies will result in increased challenges developing data-enabled and voice-enabled applications for mobile devices.

Developing data-enabled application development for mobile devices is particularly difficult as the underlying enabling technologies do not rely on standards and continue to evolve. This is a particular problem when presenting data on different mobile devices. Different display sizes on the mobile devices frequently require customized applications that match the display requirements of the mobile device. Likewise, input methods on the mobile devices also require customized drivers and application routines to accommodate a variety of input modes including alphanumeric keyboards, numeric-only keyboard and pen-based input configurations. Together, the different display devices and input modes can make developing even the most rudimentary applications for a set of mobile devices a formidable task.

In addition to the different displays and input modes, data-enabled applications must also accommodate browsers and presentation methods tailored to each of the different mobile devices. Mobile device and browser/presentation method combinations associated with data-enabled solutions include wireless phones equipped with Wireless Application Protocol (WAP) browsers, Palm OS applications, and i-Mode as well as various two-way pager and e-mail devices. Because these presentation methods may differ significantly, many applications are often only capable of working with one browser, one mobile device and one presentation method.

Even within the WAP standard, manufacturers will often create their own customized version and deviate from the standard WAP browsers. Consequently, a data-application may perform differently on a standard WAP browser by OpenWave Systems, Inc. than a WAP browser developed and designed to work on the Nokia line of cellular phones. Further, many WAP browser features are network-dependent and take advantage of proprietary services and features offered by the different carrier networks. Each difference or incompatibility described above provides additional development hurdles for developing mobile device applications.

Voice-enabled applications for mobile devices are also difficult to develop and face other technical challenges. Typically, the voice-enabled application provides voice-based information through the mobile device and performs voice recognition on the users responses to determine a course of action. Without a standard and a corresponding set of tools, these voice-enabled applications require a high-level of technical and development expertise specific to voice-application development. Even moderately complex voice-enabled application development requires a support team consisting of specialized voice talent, directors, sound engineers, dialog designers and usability testers. Because of their complexity, testing of these systems often runs into several months and adds delay and increased costs to the development cycle.

Difficulties also exist developing the infrastructure for mobile voice and data enabled applications. First, companies must be able to integrate mobile data and voice applications into existing enterprise and Internet applications. This requires expertise on both the mobile applications and existing legacy platforms to leverage existing corporate information. To avoid comprising security of these existing systems, security breeches between the non-mobile legacy systems and the new mobile systems must be identified quickly and closed.

Second, mobile applications should be developed to exploit mobile device functionality and not merely replicate existing non-mobile systems already deployed. Many valuable features on mobile devices and applications are not available on non-mobile systems thereby greatly increasing the value of the mobile voice and data applications. For example, mobile applications can take advantage of location-based services and personalized communications. Unfortunately, the general difficulty in developing mobile applications and lack of expertise often makes accommodating these valuable features impracticable.

For at least these reasons, it is important to develop systems, methods, standards, and tools to accelerate and simplify the development and deployment of data-enabled and voice-enabled mobile applications.

### SUMMARY OF THE INVENTION

One aspect of the invention can be used to integrate an application executing on a backend system with a mobile device that communicates with the application over a network. Integrating the mobile device and the application includes retrieving from a storage area a method corresponding to a function in the application on the backend system, invoking the method corresponding to the function in the application and creating an interface to the application on the backend system, receiving information from the application corresponding to information from the application requested by the mobile device and transforming the information received from the application on the backend system to a format suitable for presentation on the mobile device.

Another aspect of the invention provides for exchanging information between a mobile device and an application on a backend system. Facilitating this exchange includes tracking one or more applications on the backend system, invoking a method that causes a function on an application to execute in response to a request for the function from the mobile device enhancing functions on the mobile device using a set of application services that facilitate communication and exchange of information between the mobile device and the application on the backend system.

Yet another aspect of the invention includes presenting information onto a mobile device produced from a backend system running an application. Presenting this information includes providing a hierarchical database capable of organizing information describing characteristics of families of mobile devices, wherein information on a specific mobile device is associated with at least one family of mobile devices in the hierarchical organization of information, identifying one or more strings from a stream of information associated with a mobile device, recognizing the mobile device by comparing the one or more strings in the stream of information with corresponding strings in the hierarchical database, and selecting an entry in the hierarchical database. The entry includes characteristics compatible with the mobile device including the recognition and generation of information on the mobile device.

The details of one or more embodiments of the invention are set forth in the accompanying drawings and the description below. Other features and advantages of the invention will become apparent from the description, the drawings, and the claims.

### BRIEF DESCRIPTION OF THE DRAWINGS

FIG. 1 is a diagram illustrating a system for integrating a variety of backend application systems with a number of mobile devices;

FIG. 2 is a block diagram of the mobile application server used by the system in FIG. 1;

FIG. 3 is a block diagram of the mobile application presentation server used by the system in FIG. 1 for presenting data and voice information on the mobile devices;

FIG. 4 is a block diagram of the mobile tools suite used by the system in FIG. 1 that populates an application repository with information for integrating mobile devices and backend applications;

FIG. 5 illustrates the hierarchical organizational structure in a universal device library (UDL) to store operational information on mobile devices and the browsers they use;

FIG. 6 is a flowchart diagram of the operations performed when integrating backend systems and mobile devices by the system in FIG. 1;

FIG. 7 is a flowchart diagram of the operations performed by a mobile server to deliver information from a mobile device to backend systems in FIG. 1;

FIG. 8 is a flowchart diagram of the operations performed by the mobile presentation server in FIG. 1;

FIG. 9 is a flowchart diagram of the operations performed using the mobile tools suite to populate the application repository; and

FIG. 10 is a block diagram illustration of a computer system capable of being configured to operate as one or more portions of the system in FIG. 1.

### DETAILED DESCRIPTION

Systems and methods consistent with the present invention are used to integrate backend applications with mobile devices having different specifications and operating characteristics. Each mobile device can have different display sizes, data entry methods (i.e., keypad, touchscreen, handwriting or voice recognition), processor capabilities, communication protocols (i.e., CDMA, GSM, SMS, GPRS, AMPS and others) as well as application and browser requirements. On conventional platforms, it is difficult to deliver backend applications from an enterprise or the Internet to these mobile devices as the information and presentation schemes must be tailored to accommodate the individual peculiarities of each mobile device; essentially new applications must be developed for each application and mobile device pair.

The present invention overcomes these integration obstacles by unifying the interfaces to both the backend applications and the mobile devices. For example, methods compatible with an intermediary language are generated for each backend application and stored in an application repository. These methods are accessed and invoked by a mobile device through the intermediary language and results are rendered and presented on the individual mobile devices. Mobile devices are identified dynamically by analyzing a stream of data transmitted and received by the mobile device. This identification information is used to access a hierarchical database having characteristics of the mobile device and browsers that are then used to render the information on the mobile device. Even if the mobile device cannot be located, the closest matching family of mobile devices in the hierarchical database is located to ensure a high-level of compatibility. Many of the parameters provided within a family of mobile devices and browsers closely resemble operational characteristics of related mobile device.

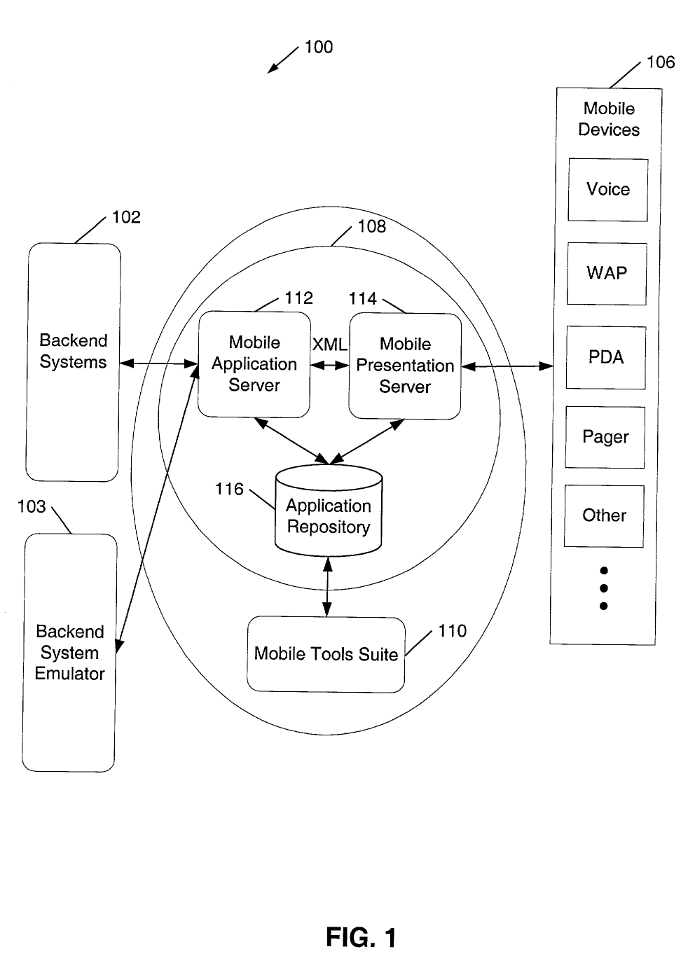

Referring to FIG. 1, a block diagram illustrates a system for integrating a variety of backend application systems with a number of mobile devices. Integration system 100, hereinafter system 100, includes backend systems 102, mobile devices 106, mobile application platform 108 and mobile tools suite 110. Backend systems 102 include enterprise and general applications developed for Customer-Relation Management (CRM), Enterprise Resource Planning (ERP), Personal Information Management (PIM), Sales Force Automation (SFA), Field Service Administration (FSA), Supply Chain Management (SCM) and other applications. Additional third-party applications may also include Siebel Systems, i2, WebMethods, SAP, Microsoft and PeopleSoft™ applications for human resources, distribution, manufacturing and supply chain management. Generally, backend systems 102 are servers originally developed for use with desktop systems that now need to be accessed through the voice and data capabilities of mobile devices 106.

Developers use tools in mobile tools suite 110 to create metadata and methods facilitating integration of backend systems 102 into mobile application platform 108. Mobile devices 106 connect to mobile application platform 108 which in turn invokes methods in real-time to gain access backend system 102.

Mobile application platform 108 includes a mobile application server 112, a mobile presentation server 114 and an application repository 116 to facilitate access to backend system 102. Backend systems emulator 103 is also included as part of mobile application platform 108 and is used for testing mobile application platform 108 before deploying platform 108 in a “live” setting. Backend systems emulator 103 simulates the interaction between mobile application server 112 and backend systems 102.

Mobile application server 112 invokes methods on behalf of mobile devices 106 to access backend systems 102. Typically, these methods are stored and retrieved from application repository 116 as needed. In one implementation, results from various backend systems 102 are converted to an intermediary language compatible with XML and passed to mobile presentation server 114 for adaptation to the particular mobile device. Mobile presentation server 114 identifies the characteristics of the mobile device including display size and browser type and modifies the information for presentation on the mobile device in the most suitable format. For example, mobile presentation server 114 can modify the resolution of an image to fit the display of a particular mobile device.

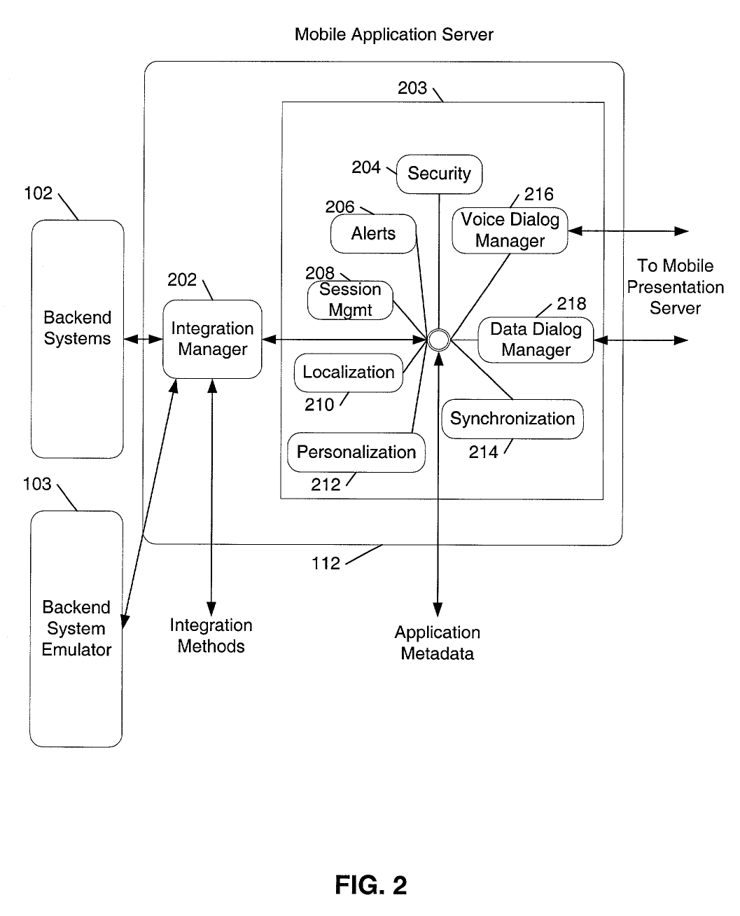

FIG. 2 is a block diagram of mobile application server 112 used by integration system 100 in FIG. 1. Mobile application server 112 provides application services 203 and an integration manager 202.

Application services include a security component 204, an alert component 206, a session management component 208, a localization component 210, a personalization component 212, a synchronization component 214, a voice dialog manager 216, and a data dialog manager 218. Application services 203 provide services typically available on multi-user and multi-process computer systems but not uniformly provided for on mobile devices 106. Having these application services 203 makes applications in backend systems 102 appear feature-rich and robust despite limited operating system functions and resource management provided on cellular phones, PDAs and other thin clients.

Security component 204 and the security features provided ensure that sensitive information remains secure when accessed through a mobile device. For example, security component 204 provides uniform authentication and authorization facilities for each of mobile devices 106. Secure component 204 can limit communication of sensitive information to mobile devices depending on the mobile device encryption capabilities, authentication and authorization of the mobile device user and the end-to-end security of the network transmitting information. In one implementation, these security mechanisms can be used to ensure that a mobile device accesses sensitive information from a personal information management (PIM) application over a secure network connection. A number of third party security methods can be plugged into and used by security component 204. Third party security methods supported by security component 204 include SecurID, Digital Certificates, HTTPs, Secure Socket Layer (SSL) and other methods developed by Security Dynamics, PKI, Certicom, Verisign, and RSA.

Alert component 206 allows mobile devices to receive real-time/synchronous or asynchronous notification of events associated with one or more applications in backend systems 102. This is useful if a response generated by an application in backend systems 102 is delayed or takes time for processing. For example, a service call assignment made on backend systems 102 generates an alert delayed until the proper service personnel are available for consultation. Alert component 206 registers the alert when the service call request is made and then notifies the proper mobile device and/or application in backend systems 102 when the specific service personnel indicates their availability. In addition, alert component 206 can send alerts to multiple mobile devices and in response the mobile devices can forward the alerts to other mobile devices and computer systems connected to mobile application platform 108.

By also transmitting state information along with the alert of a particular transaction or event, a mobile device can use preexisting information associated with the alert, respond to the alert and continue processing of the transaction or event. For example, a user receiving an alert rejecting the offer above can respond to the alert with a subsequent offer immediately and without reentering information about the bid or the user.

Session management component 208 maintains logical connectivity between the mobile device and applications in backend systems 102. Even if physical connectivity is interrupted, session information maintains a logical connection and makes it appear that an mobile device has a continuous or uninterrupted connection to applications on backend systems 102. This is useful if connectivity between the mobile device and mobile application is accidentally interrupted or terminated without proper termination procedures. If state information is stored, session management component 208 can re-establish communication with an application and recreate some or all of the processing. Also, session management 208 can also be used to gracefully terminate communication with backend systems 102 including initiation of database roll-back or other similar events to ensure data integrity and reliability in transactions.

Synchronization component 214 facilitates updating a mobile device with information while a mobile device is offline and applications on backend systems 102 continue to process information and transactions. When the mobile device is brought back on-line, synchronization component 214 updates information stored on mobile devices 106 according to information on one or more applications on backend systems 102. Conversely, synchronization component 214 also facilitates updating applications on backend systems 102 if information is introduced or modified on the mobile device while the device is offline. Localization component 210 uses location based services and locale information to customize features of an application in backend systems 102. Location based services locates a mobile device using technologies such as Global Positioning Systems (GPS). This information is provided applications in backend systems 102 to tailor information to a users geographic position. For example, a person accessing a CRM system with a mobile device can use location-based information to request a list of customers within a given distance from the person's location.

Locale information provided to the application by localization component 210 specifies how to tailor information for a particular country, region or culture. In many applications a locale variable causes the application to generate information in a preferred language, currency, date/time format and other information peculiar to the geographic or cultural region. In one implementation, localization component 210 acts as a proxy for mobile devices 106 and selects a locale variable in the application for generating information. Information generated by the one or more applications in backend systems 102 correlates to the selected locale and appears on mobile devices 106 in the correct format or language.

If the application in backend systems 102 does not offer multiple locales, an alternate implementation of the present invention translates information generated by the application into the locale selected for use on mobile devices 106. For example, this may include automatically translating the default language in the application into the language associated with the desired locale. This latter implementation may also automatically perform currency translations between a default currency used by the application and the currency in the desired locale.

Personalization component 212 provides support for a user to select options and preferences for interacting with an application on backend systems 102. For example, one personalization includes automatic entry of login/passwords and requesting “favorite” information from applications in backend systems 102. Using personalization, a sales manager can set personalization component 212 to automatically login from a mobile device and request a “favorite” monthly sales report be generated and customized according to specific format and content requirements.

Voice dialog manager 216 in FIG. 2 manages communications and related transformations between voice and data information. Facilities for speech recognition and speech-synthesis (text-to-speech) transformations are provided through voice-dialog manager 216. Data information passes through voice dialog manager 216 and is converted to a series of choices in a voice-dialog that the user hears on a mobile device. These choices can be a fixed set of voice menu choices or choices made available through a natural-language system. Voice-dialogs can be setup in advance statically or dynamically as the user interacts with the mobile device. In each implementation, voice dialog manager 216 receives and processes a user's response using a voice recognition engine. This processing includes converting voice commands and information into to text for further processing by applications in backend systems 102.

Data dialog manager 218 in FIG. 2 manages data used by the applications in backend system 102 and their representation on mobile devices 106. Data information passes through data dialog manager 218 and is presented on mobile devices 106 using menus and other types of user-interface components. Data can be represented statically using predetermined menus or dynamically using menus created in response to certain data conditions. In one implementation, data dialog manager 218 is responsive to data compatible with XML and receives additional formatting control for displaying XML using style sheets compatible with Extensible Stylesheet Language (XSL). After displaying the data, the mobile device receives a user's response through the user-interface components and processes the response using data dialog manager 218. Data dialog manager 218 recognizes and converts certain commands and information into to text for further processing by applications on backend systems 102.

Integration manager 202 tracks specific applications available in backend systems 102 and the corresponding methods registered for accessing these systems stored in application repository 116. Integration manager 202 intercepts requests for applications in backend systems 102 while an appropriate method or methods are identified for execution. Integration manager 202 receives requests in an intermediary language such as XML and then invokes a method in a language or format appropriate for the particular application on backend systems 102. In certain cases, integration manager 202 can also be used to ensures proper XML code is generated and used during data processing. Languages, interface protocols and syntaxes supported by integration manager 202 are compatible with XML, SQL, HTML, LDAP, CORBA, COM, and IIOP. For example, integration manager can be implemented using a hash table that maps applications and functions offered by the applications to specific methods developed in the appropriate language and interface protocol. Accordingly, a Microsoft application like Outlook may be accessed using a method written in COM while an object-oriented CRM application written in Java may be accessed using CORBA compatible methods.

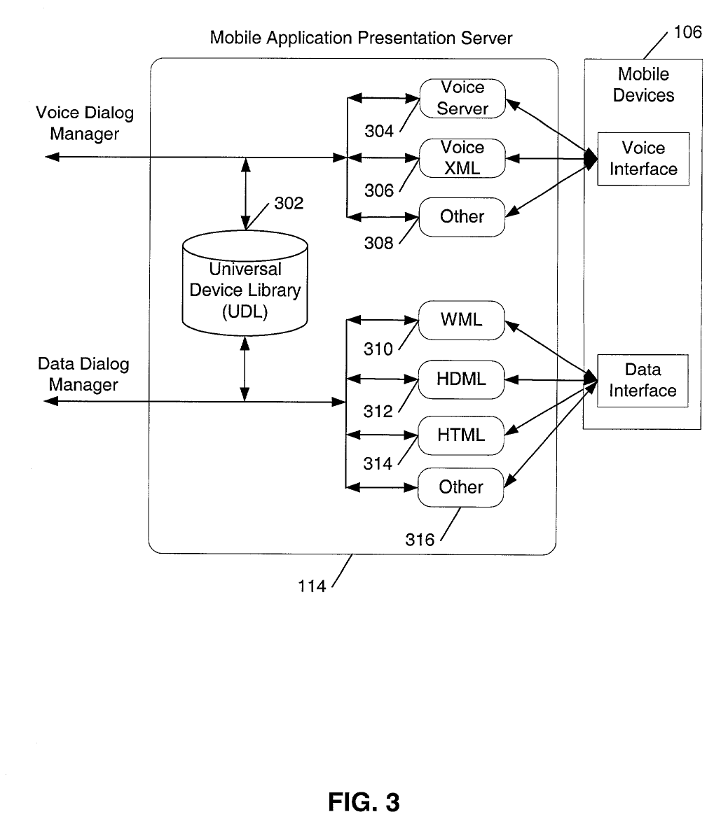

FIG. 3 is a block diagram of mobile application presentation server 114 used by the system in FIG. 1 to properly present data and voice information to mobile devices 106. Mobile application presentation server 114 includes a universal device library (UDL) 302, a set of voice device adaptors 304, 306 and 308 along with a set of data device adaptors 310, 312, 314 and 316 for presenting information on mobile devices 106.

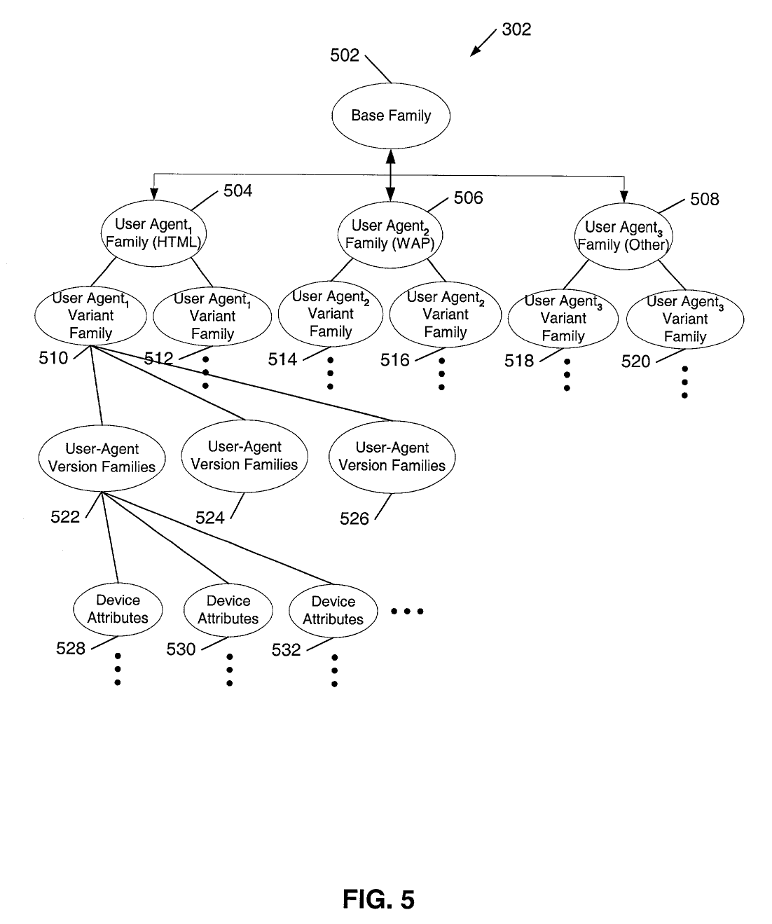

Presenting voice and data information is difficult because the mobile devices have many different designs and functional capabilities. Of course, the more accurately one can identify the features and capabilities of a mobile device then the more precisely and efficiently information can be presented. UDL 302 stores information on a wide range of mobile devices arranged in a hierarchical organization that emphasizes characteristics shared between the various mobile devices. Ideally, if a mobile device is identified in UDL 302 then the characteristics of the mobile device are well-known and both voice and data information can be readily presented. However, even if the mobile device cannot be identified then characteristics associated with a “family” of similar devices in UDL 302 are located and used. Because families of mobile devices share a number of common elements, data and voice information can still be accurately and efficiently presented on the mobile device. Additional information on the hierarchical organization of information in UDL 302 is described later herein in conjunction with FIG. 5.

Mobile presentation server 114 selects the voice, data or voice and data device adaptors for presenting on mobile devices by analyzing a stream of data transmitted and received by the target mobile device. This locates an entry in UDL 302 that identifies voice and data capabilities of the mobile device as well as features associated with a browser used on the mobile device. In the case of voice communication, mobile presentation server 114 selects one of voice server 304, voice XML 306 or other voice device adaptor 308 to transmit voice information to a user for interaction. Depending on the voice device adaptor selected, a different voice dialog may be accessed and retrieved from application repository 116.

For data communication, mobile presentation server 114 selects one of WML 310, HDML 312, HTML 314, or other data device adaptor 316 to transmit data information to a display associated with mobile device 106. Each different data device adaptor may require mobile presentation server 114 to access application repository 116 for details on rendering different protocols or languages properly on the mobile device display. For example, putting titles on the display of a mobile device may be handled differently for different languages or protocols. In one language, there may not be a standard method for putting titles on the screen of a mobile display device. If that occurs, the corresponding data-device adaptor may be instructed to insert title information and render titles on each screen. In contrast, another language may automatically render screen title information on each screen. Accordingly, the corresponding device adaptor for this language would not be required to insert screen titles since the underlying language supports rendering screen titles.

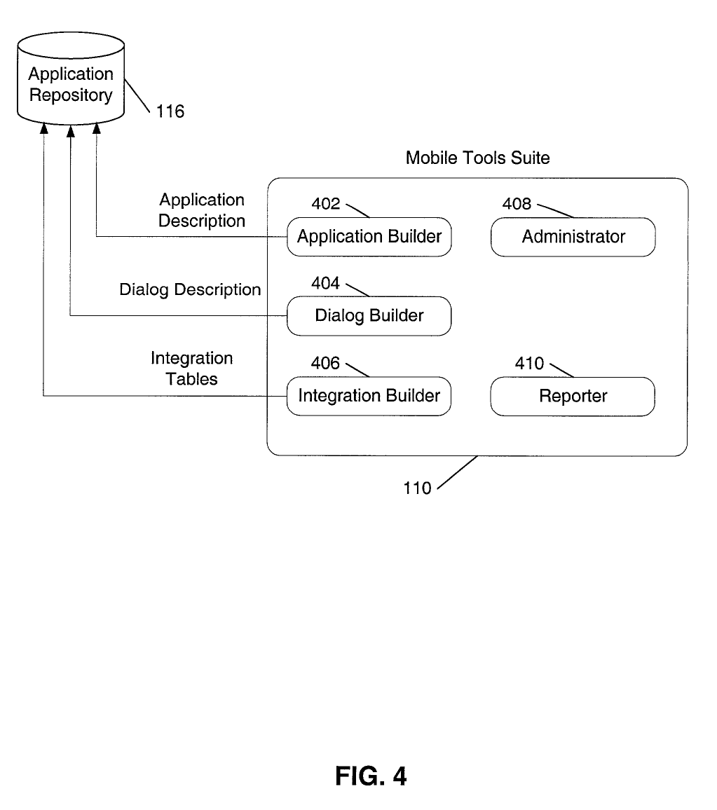

FIG. 4 is a block diagram of mobile tools suite 110 used by the system in FIG. 1 to populate an application repository with information used for integrating mobile devices and backend applications. Mobile tools suite 110 includes an application builder 402, a dialog builder 404, an integration builder 406, an administrator component 408 and a reporter component 410.

A developer uses application builder 402 to create application metadata and other information describing the interaction of an application in an intermediary language. In one implementation, this intermediary language is compatible with XML and is typically stored in application repository 116. Mobile application presentation server 114 in FIG. 3 uses this metadata and other information to create menus, forms, messages and other user-interface elements in a language appropriate for display on the target mobile device. The metadata provides mobile application presentation server 114 with abstract descriptions of the application operation and assists in generating platform specific code to display these elements on the mobile display. In FIG. 3, mobile application presentation server 114 selects and uses one of data application device adaptor 304, 306, and 308 to generate this platform specific code however device adaptors compatible with other languages and syntaxes can also be used.

Dialog builder 404 performs a similar function as application builder 402 but for voice device adaptors 310, 312, 314 316 and is also compatible with other languages and syntaxes. Metadata created through dialog builder 404 describing the voice-dialogs is also stored in application repository 116. Metadata for the voice-dialogs creates voice rather than data based interactions and is not limited by a display size or the number and size of buttons available on a mobile device. Instead, the voice interactions are presented over a mobile device speaker and responses are received over a microphone on the mobile device.

Integration builder 406 creates a set of methods and routines used to access applications on backend systems 102. A developer creates methods using interface builder 406 that access applications through an appropriate application programming interface or a native programming language used in the application. For example, methods for accessing Microsoft products may be developed in Visual Basic or using the COM/DCOM interface protocol. These methods are stored in advance in a table and associated with certain functions typically requested by mobile devices 106. As previously described, mobile application server 112 uses integration manager 202 to access and invoke these methods in the table as required and then pass the resulting information produced to the mobile devices in an language compatible with XML or another intermediary language.

Administrator component 408 is used to control access to features of integration system 100 and the entering of information in application repository 116 and UDL 302. Updates made to UDL 302 include entering characteristics of new devices and updating existing device characteristics with new or upgraded features.

Reporter component 412 provides tools for gathering statistics and information on the access of applications on backend systems 102 through mobile devices 106. This includes collecting the number and frequency of times applications accessed by mobile devices through implementations of the present invention. In addition, reporter component 412 gathers throughput data measuring the speed which information is generated by the applications on backend systems 102 and presented on mobile devices 106.

FIG. 5 illustrates the hierarchical organizational structure in UDL 302 for storing information about mobile devices and their corresponding browsers. UDL 302 provides a comprehensive listing of characteristics for families of mobile devices and specific mobile devices associated with these families.

A base family at the top of the hierarchy has a set of attributes passed down to the devices in the lower part of the tree. Each entry in the hierarchy adds more attributes that are passed down or inherited by the children devices that descend below. Device attributes including display size and resolution, cache size, input methods, and acceptable content types as well as browser or browsers are stored in UDL 302. Many of these device attributes relate to the user-agent processing data in the browser. Other device attributes relate to the physical characteristics of the mobile device.

Stylesheets are also associated with entries in UDL 302 and are used to provide a uniform presentation of information across families of devices. In one implementation, these style sheets are compatible with the XSL style sheet description language. Like other attributes in the tree hierarchy, children devices entered below inherit the style sheet attributes. In one implementation, additional style feature causes the style to change for descendant entries but not the parent entries.

In FIG. 5, UDL 302 is organized into families of mobile devices that operate in a similar manner or are compatible with similar software applications. In the implementation illustrated in FIG. 5, UDL 302 has a base family 502, a set of user agent families 504, 506, 508, and a set of user-agent variants 510, 512, 514, 516, 518, 520. Below user-agent variants are user-agent version families and device attributes of the physical devices. If the exact mobile device and user-agent/browser cannot be identified in UDL 302, a family of devices compatible to the mobile device can be located by moving up the tree until a family of related mobile devices is identified. For example, the top-level entry for a WAP compatible Nokia phone is likely to provide reasonable compatibility with most other Nokia WAP phones.

Base family 502 describes the grouping criteria for the families below. It is the “root” or base family that encompasses all mobile devices, browsers and corresponding user-agents. User-agent families 504, 506 and 508 groups together mobiles devices that user a similar user-agent. In one implementation, the user-agent families are grouped according to the different languages user-agents process including HTML, WAP and other languages. Within each language exists user-agent variants 510, 512, 514, 516, 518 and 520. In one implementations, these user-agent variants describe user-agents that accept the same language but may be produced by different vendors. For example, one user-agent variant may be developed by Nokia while another user-agent variant is developed by OpenWave. User-agent variants can also describe subsets of a language like HTML that have distinctive differences. Compact HTML is a variant of HTML used by some user-agents while iMode is another variant of HTML that uses different user-agents in the browsers. User-agent version families 522, 524 and 526 relates to different versions of a user-agent in a particular variant. Eventually, attributes of specific physical devices are described as device attributes 528, 530 and 532. This latter entries describe the actual combination of the physical device in light of the particular user-agent version family.

This hierarchical organization and grouping makes UDL 302 easy to manage and use for organizing many different types of mobile devices. Adding new mobile devices to UDL 302 is relatively easy because the new entries inherit all the features of parent devices in the tree. For example, a new Nokia device with a larger display and more memory would be added into the tree below similar Nokia devices without explicitly adding all the features in common with the parent devices in the tree. Similarly, a mobile device running a new WAP version would be added to the tree below language 506 to describe the differences in the version.

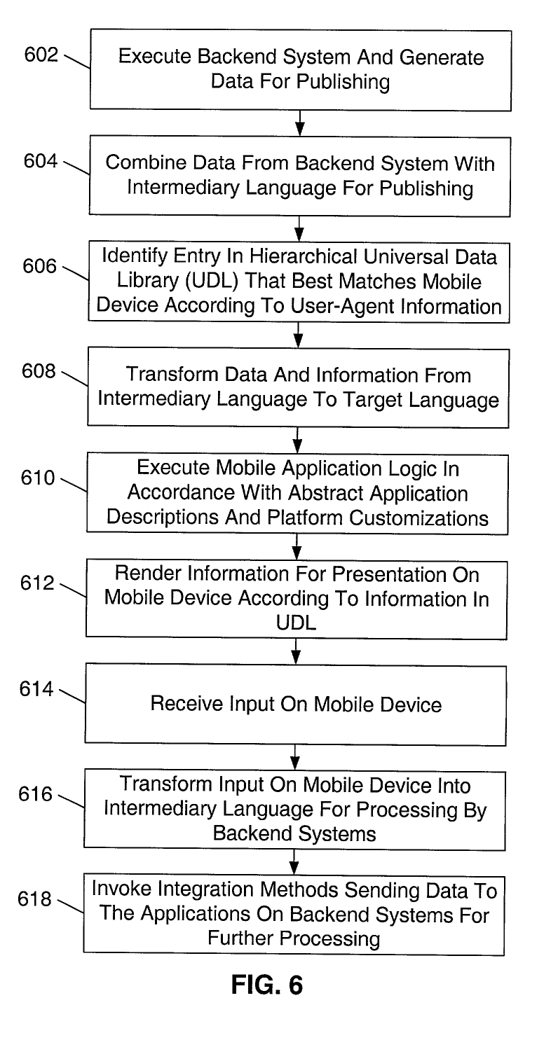

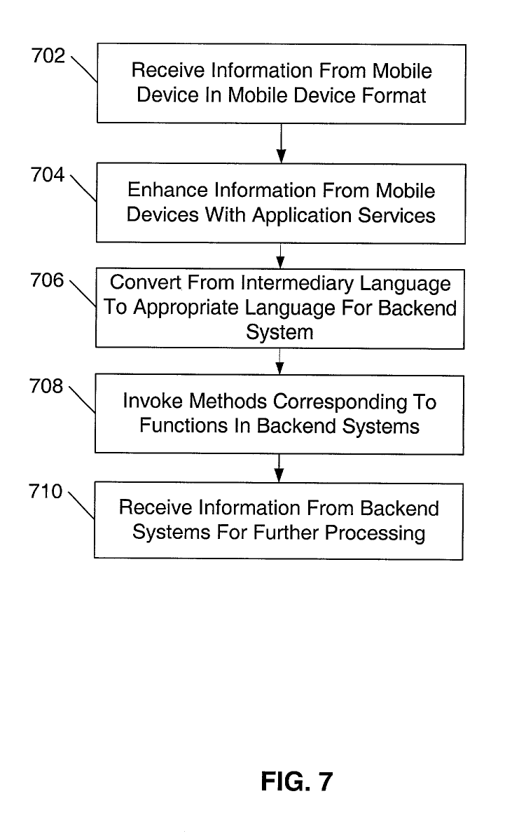

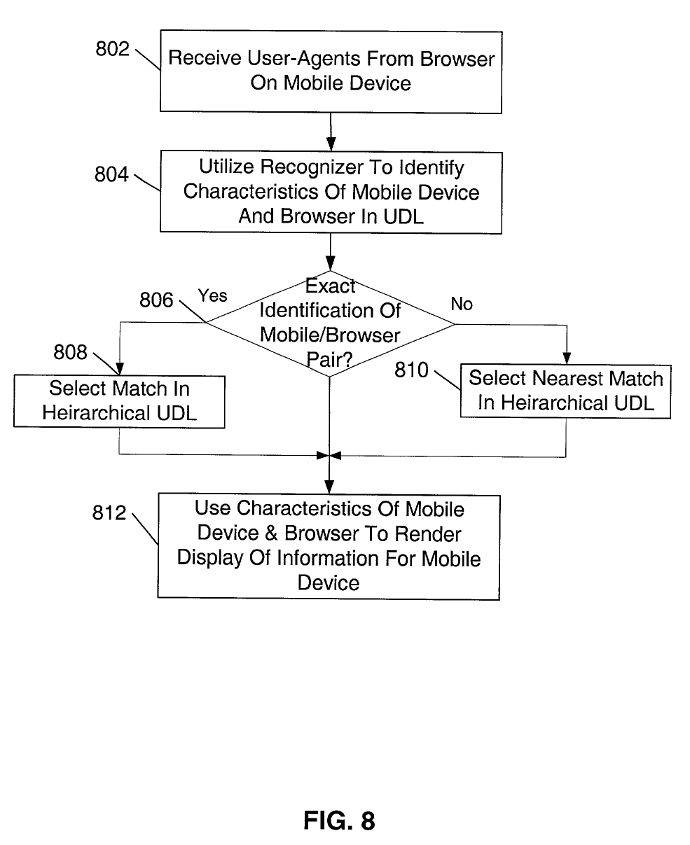

FIG. 6 is a flowchart diagram of the overall operations performed when integrating backend systems and mobile devices into system 100 in FIG. 1. Additional details on these operations are described later herein in conjunction with FIG. 7 and FIG. 8.

Initially, an application in backend systems 102 is executed that generates data for publishing on a mobile device (602). This data is combined with an intermediary language for further processing (604). For example, this intermediary language can be compatible with XML or another intermediary language. Data transmitted and received by the mobile device is used to identify the proper entry in UDL 302 (606). In one implementation, user-agent information sent from a browser includes information that identifies the browser and version as well as the target mobile device processing the information.

Once the mobile device is identified, the data and information is transformed from the intermediary language to the target language (608). Voice device adaptors 304, 306, and 308 convert the data into appropriate voice dialogs compatible with voice server 304, voiceXML 306 or other voice languages for use on the mobile device. Data adaptors 310, 312, 314, and 316 are used to convert data in the intermediary language into menus, messages, and other user-interface elements for display on mobile devices 106. Typically, abstract information about the application stored in application repository 116 is also used to create these user-interface elements for the display. Once generated, the mobile application logic and presentation instructions are executed (610) and the information is rendered on the mobile device in accordance with UDL 302 (612). A user operating the mobile device enters data or voice commands in response to the information provided. This data and/or voice information is received on the mobile device (614).

The reverse of the process described above is performed to get the information from the mobile device to the application in backend systems 102. This includes transforming input received on the mobile device to an intermediary language for further processing (616). For example, this intermediary language may also be compatible with XML. Integration manager 202 intercepts the intermediate language and invokes appropriate methods and sends information to the applications for further processing (618).

FIG. 7 is a flowchart diagram of the operations performed by mobile application server 112 to deliver information from a mobile device to backend systems 102 in FIG. 1. This flowchart provides additional operations associated with integration manager 202 invoking methods to access applications (618) in FIG. 6.

Mobile application server 112 receives information from a mobile device in a mobile device format (702). The information from the mobile device can be either voice information from a voice-enabled application or data from a data-enabled application. Voice information is converted for further processing using speech recognition. In one implementation, voice information from the mobile device is in a format compatible with Voice XML. Of course, voice representations compatible with other formats other than Voice XML can also be used with the various implementations of the invention. Speech recognition can utilize one or more different types of speech-recognition engines including systems developed by Nuance Communications of Menlo Park, Calif.

Mobile application server 112 enhances the information with application services that facilitate communication and the exchange of information between the mobile device and the application on the backend system 102 (704). As described above, these application services include security, session management, synchronization, alert processing, localization, and personalization services. Alternate implementations may include greater or fewer application services as deemed necessary to integrate backend systems 102 with mobile devices 106.

Mobile application server 112 processes data information from an intermediary language into an appropriate language for an application in backend systems 102 (706). In one implementation, mobile application server 112 receives information compatible with XML and performs transformations that make it compatible with one or more languages and/or protocols including Structured Query Language (SQL), HyperText Markup Language (HTML), Lightweight Directory Access Protocol (LDAP), Common Object Request Broker Architecture (CORBA) and Component Object Model(COM).

Within mobile application server 112, integration manager 202 in FIG. 2 is tasked with performing additional transformations and invoking methods corresponding to functions associated with one or more applications in backend systems 102 (708). As illustrated in FIG. 1 and FIG. 2, integration manager 202 obtains integration methods from application repository 116 generated in advance using mobile tools suite 110. Applications associated with backend systems 106 perform the requested functions and integration manager 202 receives the results (710). To process the results, one or more operations described above are performed in reverse. Application services 203 and corresponding operations described above are used as a guideline to processing the results returned from backend systems 106 before they are presented on mobile devices 106. To convert text-to-voice and present on mobile devices 106, voice synthesis is performed using one or more different types of voice synthesis engines including systems developed by Lernout & Hauspie Speech Products N.V. of Belgium.

FIG. 8 is a flowchart diagram of the operations performed by the mobile presentation server 114 in FIG. 1. This flowchart provides additional details for presenting information on mobile devices (612) as described in FIG. 6.

A mobile device sends a request for information from applications on backend systems 102 that mobile presentation server 114 intercepts and processes. A portion of the request passed onto mobile application server 112 is used to invoke methods and obtain information from applications. Another portion of the request received by mobile presentation server 114 includes user-agent and accept string headers that facilitate identifying capabilities of the mobile device and browser (802). In one implementation, the user-agent header and accept header are placed in an HTTP header along with other header information by a user-agent associated with the browser of a mobile device. The user-agent header identifies the version of the user-agent associated with the browser and in some cases the capabilities of the user-agent. The accept header further defines capabilities of the useragent by indicating strings or commands the user-agent associated with the browser will “accept” and process correctly. Together, the user-agent header and accept header assists mobile presentation server 114 to interact and provide proper information to a user-agent.

A recognizer associated with mobile presentation server 114 uses the user-agent header, the accept header and potentially other information to identify an entry or entries in UDL 302 and determine characteristics of the mobile device and browser (804). In one implementation, the recognizer performs a series of operations comparing the user-agent header and accept header information with entries in UDL 302. These comparison operations identify the mobile device and browser entry in UDL 302 or identify a family of devices and browsers that closely relate to the mobile device and browser combination.

Depending on the mobile device used, the recognizer may be able to identify the mobile device and browser in UDL 302 (806). If a match is made, mobile presentation server 114 selects and uses the definitions and characteristics from UDL 302 for the specific mobile device and the browser (808). Alternatively, if the mobile device and browser cannot be identified (806), mobile presentation server 114 selects the nearest match in the hierarchy of UDL 302 (810). Generally, the nearest match in UDL 302 identifies a family of browsers and mobile devices in the hierarchy with definitions and characteristics that closely match the targeted mobile device. As previously described, these definitions and characteristics can include display size and resolution, cache size, input methods, and acceptable content types as well as preferred browser or browsers for rendering information. Using this information from applications on backend systems, mobile presentation server 114 facilitates rendering results on the target mobile device 106 (812).

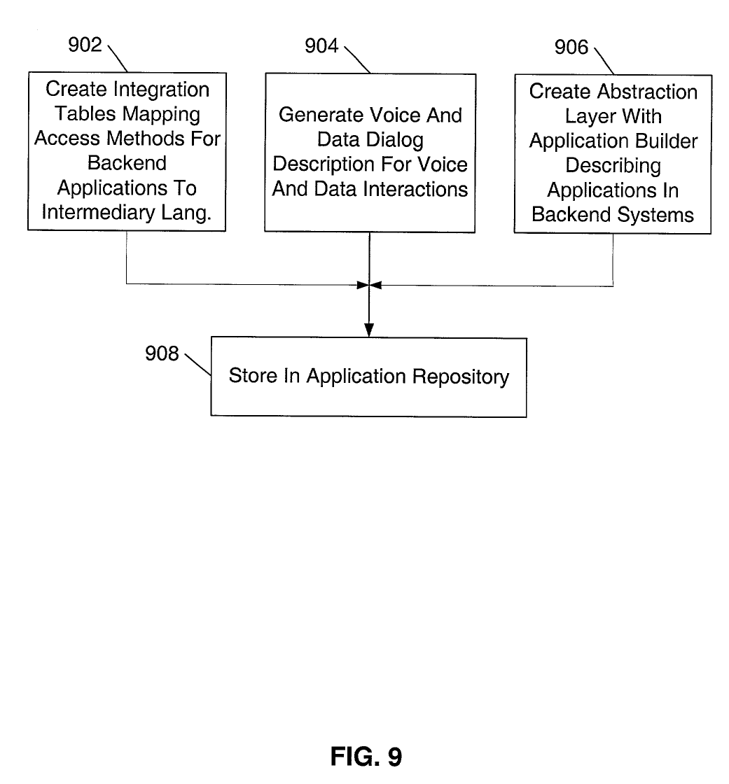

FIG. 9 is a flowchart diagram of the operations performed using mobile tools suite 110 to populate application repository 116. A system administrator or person typically uses these tools to integrate mobile devices 102 with applications in backend systems 106.

Integration builder 406 creates tables mapping access methods to functions within applications on backend systems 102 (902). These access methods cause applications in backend systems 106 to execute specific functions and provide results. For example, access methods can be created that cause a CRM application to generate contact information for a particular customer. Once created, integration builder 406 stores this access method in application repository 116 (908).

Dialog builder 404 builds dialogs for both voice and data interactions (904). For voice applications on a mobile device, dialog builder 404 specifies a combination of voice prompts, natural-language processing and voice preferences used by a mobile device when interacting with an application on backend systems 106. These voice-dialogs are also stored in application repository 116 (908) and used to aurally present information. Similarly, for data applications on a mobile device, dialog builder 404 specifies a combination of menu choices, input methods and data preferences used by a mobile device when interacting with a particular application in backend systems 106. These data-dialogs are also stored in application repository 116 (908) and used to visually present information. Of course, hybrid applications on a mobile device with both aural and visual interfaces would store a combination of voice-processing and data-processing instructions described above in application repository 116.

Application builder 402 describes applications in backend systems 106 with an abstraction layer (906). This abstraction layer is used by various application services 203 to coordinate behavior between the operation of mobile devices 106 and applications in backend systems 102. Information in the abstraction layer can include security information, alert information, session management information, locale information, personalization information, and synchronization information in accordance with the description above. This information is also stored in application repository 116 (908).

Aspects of the invention can be implemented in digital electronic circuitry, or in computer hardware, firmware, software, or in combinations of them. Apparatus of the invention can be implemented in a computer program product tangibly embodied in a machine-readable storage device for execution by a programmable processor; and method steps of the invention can be performed by a programmable processor executing a program of instructions to perform functions of the invention by operating on input data and generating output.

The invention can be implemented advantageously in one or more computer programs that are executable on a programmable system including at least one programmable processor coupled to receive data and instructions from, and to transmit data and instructions to, a data storage system, at least one input device, and at least one output device. Each computer program can be implemented in a high-level procedural or object-oriented programming language, or in assembly or machine language if desired; and in any case, the language can be a compiled or interpreted language. Suitable processors include, by way of example, both general and special purpose microprocessors. Generally, a processor will receive instructions and data from a read-only memory and/or a random access memory.

Typically, a computer will include one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM disks. Any of the foregoing can be supplemented by, or incorporated in, ASICs (application-specific integrated circuits).

To provide for interaction with a user, the invention can be implemented on a computer system having a display device such as a monitor or LCD screen for displaying information to the user and a keyboard and a pointing device such as a mouse or a trackball by which the user can provide input to the computer system. The computer system can be programmed to provide a graphical user interface through which computer programs interact with users.

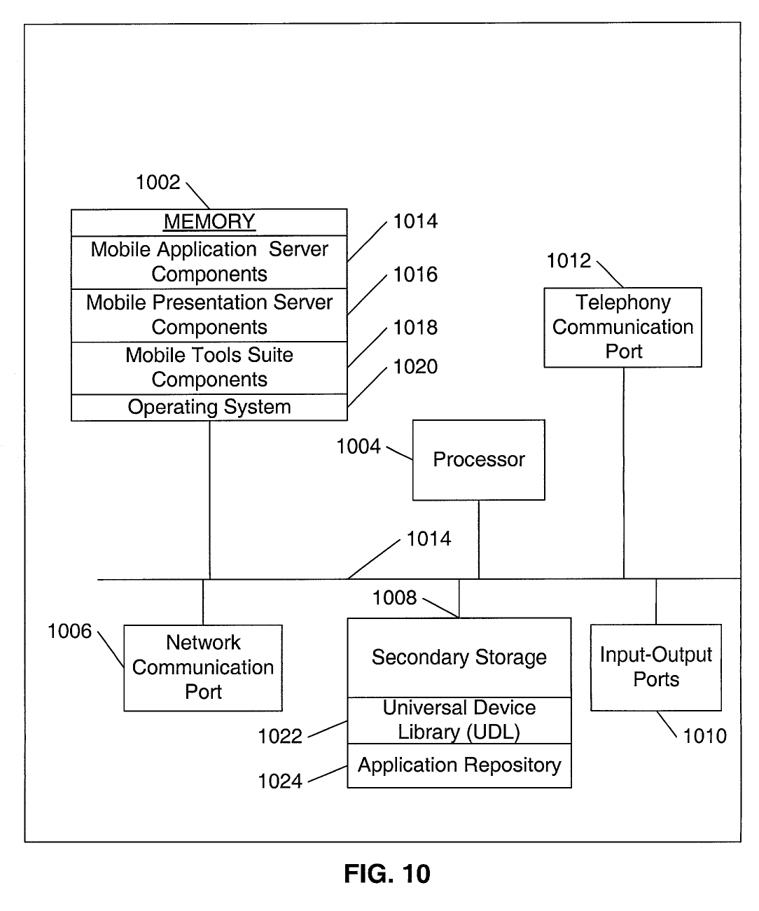

An example of one such type of computer is shown in FIG. 10 and is capable of being configured to operate as one or more portions of the system in FIG. 1. Either mobile application server 112, mobile presentation server 114, application repository 116 or mobile tools suite 110 in FIG. 1 can be implemented in accordance with the present invention using one or more software or hardware components as illustrated and described. Computer 1000 includes a memory 1002, a processor 1004, a network communication port 1006, a secondary storage 1008, input-output ports 1010 and telephony communication port 1012 coupled together over bus 1014. Network communication port 1006 can be connected to the Internet or other public network while telephony communication port 1012 is typically connected to a switched network used for voice communication. Computer 1000 can be preprogrammed, in ROM, for example, or is programmed (and reprogrammed) by loading a program from another source (for example, from a floppy disk, a CD-ROM, or another computer).

Memory 1002 is capable of holding computer programs, including programs implementing aspects of the present invention, stored in secondary storage 1008 or on a remote device connected over a network coupled to network communication port 1006. Programs include mobile application server components 1014, mobile presentation server components 1016, mobile tools suite components 1018 and an operating system 1020. Universal device library (UDL) 1022 is typically stored on secondary storage 1008 as is application repository 1024.

While specific embodiments have been described herein for purposes of illustration, various modifications may be made without departing from the spirit and scope of the invention. For example, data device adaptors and voice adaptors compatible with WML, HDML, HTML and Voice XML respectively are described yet data device adaptors and voice adaptors compatible with other languages and syntaxes can also be used. Accordingly, the invention is not limited to the above-described implementations, but instead is defined by the appended claims in light of their full scope of equivalents.

What is claimed is:

1. A system for integrating an application executing on a backend system with a mobile device capable of communicating to the backend system over a network, comprising:
a mobile application server capable of interfacing with the application by invoking methods corresponding to functions in the application and receiving information from the application;
a mobile presentation server capable of receiving the application information from the mobile application server and transforming the information for presentation on a mobile device; and
an application repository capable of storing the methods used by the mobile application server for interfacing with the application.

2. The system of claim 1 further including a hierarchical database of mobile device information capable storing information describing the characteristics of a mobile device and a family of related mobile devices wherein the mobile presentation server uses this information in the hierarchical database for presenting information from the application onto the mobile device.

3. The system of claim 1 wherein the mobile application server further includes,
an integration manager that maps the methods to functions in the application and is capable of mapping at least one function to at least one method in response to a request for application information from the mobile device.

4. The system of claim 1 wherein the mobile application server further includes a set of application services capable of enhancing functionality on a mobile device and improving the communication and exchange of information between the mobile device and the application on the backend system.

5. The system of claim 1 wherein the mobile application presentation server further includes a voice device adaptor capable of performing voice processing functions and a data device adaptor, wherein the voice device adaptor and data device adaptor facilitate the exchange of voice information and data information with the mobile device.

6. A method of integrating an application executing on a backend system with a mobile device capable of communicating to the backend system over a network, comprising:
retrieving from a storage area a method corresponding to a function in the application on the backend system;
invoking the method corresponding to the function in the application and creating an interface to the application on the backend system;
receiving information from the application corresponding to information from the application requested by the mobile device; and
transforming the information received from the application on the backend system to a format suitable for presentation on the mobile device.

7. The method of claim 6 wherein the transforming further includes retrieving information describing the characteristics of a mobile device from a hierarchical database of mobile device information describing the characteristics of the mobile device and a family of mobile devices related to the mobile device.

8. The method of claim 6 wherein invoking the method further includes, mapping at least one method to at least one function associated with an application on the backend system, wherein the function is capable of providing information from an application on the backend system when executed.

9. The method of claim 6, further comprising,
enhancing functionality on the mobile device using a set of application services that facilitates improving communications and the exchange of information between the mobile device and the application on the backend system.

10. The method of claim 7 further comprising,
rendering information on the mobile device in accordance with the hierarchical database of mobile devices having information describing the characteristics of the mobile device and a family of mobile devices related to the mobile device.

11. A system for exchanging information between a mobile device and an application on a backend system, comprising:
an integration manager component capable of tracking one or more applications on the backend system and further capable of invoking a method that causes a function in an application to execute in response to a request for the function from the mobile device; and
a set of application services capable of enhancing functionality on a mobile device and further capable of improving the communication and exchange of information between the mobile device and the application on the backend system.

12. The system of claim 11 wherein the set of application services includes:
a security component capable of controlling the information exchanged between the mobile device and the application on the backend system according to security levels associated with the mobile device and the application.

13. The system of claim 11 wherein the set of application services includes:
an alert component capable of facilitating synchronous and asynchronous communications of events between the application on the backend system and the mobile device.

14. The system of claim 11 wherein the set of application services includes:
a session management component capable of managing and maintaining logical connectivity for sessions between the application on the backend systems and the mobile device.

15. The system of claim 11 wherein the set of application services includes:
a synchronization component capable of updating information on both the mobile device and the application on the backend system and ensuring that the information on both the mobile device and the application are consistent when information is modified on either the mobile device or the application.

16. The system of claim 11 wherein the set of application services includes:
a localization component capable of utilizing location based services and locale information to customize features of an application on the backend system.

17. The system of claim 11 wherein the set of application services includes:
a personalization component capable of customizing an application on the backend system according to a user's personal options and preference when accessing the application from the mobile device.

18. The system of claim 11 wherein the set of application services includes:
a voice dialog manager component capable of managing communications and transformations between data communications used on the application and voice communications used on the mobile device.

19. The system of claim 11 wherein the set of application services includes:
a data dialog manager component capable of managing communications and transformations between data communications used on the application and data communications used on the mobile device.

20. A method of exchanging information between a mobile device and an application on a backend system, comprising:
tracking one or more applications on the backend system;
invoking a method that causes a function on an application to execute in response to a request for the function from the mobile device; and
enhancing functionality on the mobile device using a set of application services that facilitate communication and exchange of information between the mobile device and the application on the backend system.

21. The method of claim 20 wherein enhancing functionality further comprises, controlling the information exchanged between the mobile device and the application on the backend system according to security levels associated with the mobile device and the application.

22. The method of claim 20 wherein enhancing the functionality further comprises, facilitating synchronous and asynchronous communications of events between the application on the backend system and the mobile device through the use of alerts.

23. The method of claim 20 wherein enhancing the functionality further comprises, managing and maintaining logical connectivity for sessions between the application on the backend systems and the mobile device.

24. The method of claim 20 wherein enhancing the functionality further comprises, updating information on both the mobile device and the application on the backend system and ensuring that the information on both the mobile device and the application are consistent when information is modified on either the mobile device or the application.

25. The method of claim 20 wherein enhancing the functionality further comprises, utilizing location based services and locale information to customize features of an application on the backend system.

26. The method of claim 20 wherein enhancing the functionality further comprises, customizing an application on the backend system according to a user's personal options and preferences when accessing the application from the mobile device.

27. The method of claim 20 wherein enhancing the functionality further comprises, managing communications and transformations between data communications used on the application and voice communication used on the mobile device.

28. The method of claim 20 wherein enhancing the functionality further comprises, managing communications and transformations between data communications used on the application and data communication used on the mobile device.

29. A system for presenting information onto a mobile device from a backend system running an application, comprising:
a hierarchical database capable of organizing information describing characteristics of families of mobile devices wherein information on a specific mobile device is associated with at least one family of mobile devices in the hierarchical organization of information; and
a set of device adaptors capable of matching a stream of information associated with the mobile device with an entry in the hierarchical database of information to determine the characteristics of the mobile device.

30. The system of claim 29 wherein the set of device adaptors includes a data device adaptor capable of using the entry identified in the hierarchical database to generate data compatible with the mobile device.

31. The system of claim 29 wherein the set of device adaptors includes a voice device adaptor capable of using the entry identified in the hierarchical database to generate voice information compatible with the mobile device.

32. The system of claim 30 wherein the data information is compatible with XML.

33. The system of claim 31 wherein the voice information is compatible with VoiceXML.

34. A method of presenting information on a mobile device produced from a backend system running an application, comprising:
providing a hierarchical database capable of organizing information describing characteristics of families of mobile devices, wherein information on a specific mobile device is associated with at least one family of mobile devices in the hierarchical organization of information;
identifying one or more strings from a stream of information associated with a mobile device;
recognizing the mobile device by comparing the one or more strings in the stream of information with corresponding strings in the hierarchical database;
selecting an entry in the hierarchical database wherein the entry includes characteristics compatible with the mobile device based on the recognition; and
generating information on the mobile device according to the characteristics selected from the entry in the hierarchical database.

35. The method of claim 34 wherein the identifying step further comprises locating a user-agent header in the stream of information associated with the mobile device.

36. The method of claim 34 wherein the identifying step further comprises locating an accept header in the stream of information associated with the mobile device.

37. The method of claim 34 wherein selecting an entry in the hierarchical database further comprises,
determining if an entry in the hierarchical database corresponds to the mobile device; and
selecting an entry from the hierarchical database having characteristics corresponding to a family of mobile devices compatible with the mobile device and in based on the determination.

38. The method of claim 34 wherein the generating includes rendering information on a display of the mobile device according to the selected entry in the hierarchical database.

39. The method of claim 34 wherein the generating includes converting data information into voice information for use on the mobile device.

40. The method of claim 39 further comprising performing voice recognition on voice information received from the mobile device.

41. A computer program product, tangibly stored on a computer-readable medium, for integrating an application executing on a backend system with a mobile device capable of communicating to the backend system over a network, comprising instructions operable to cause a programmable processor to:
retrieve from a storage area a method corresponding to a function in the application on the backend system;
invoke the method corresponding to the function in the application and creating an interface to the application on the backend system;
receive information from the application corresponding to information from the application requested by the mobile device; and
transform the information received from the application on the backend system to a format suitable for presentation on the mobile device.

42. A computer program product, tangibly stored on a computer-readable medium, for exchanging information between a mobile device and an application on a backend system, comprising instructions operable to cause a programmable processor to:
track one or more applications on the backend system;
invoke a method that causes a function on an application to execute in response to a request for the function from the mobile device; and
enhance functionality on the mobile device using a set of application services that facilitate communication and exchange of information between the mobile device and the application on the backend system.

43. A computer program product, tangibly stored on a computer-readable medium, for presenting information on a mobile device produced from a backend system running an application, comprising instructions operable to cause a programmable processor to::
provide a hierarchical database capable of organizing information describing characteristics of families of mobile devices, wherein information on a specific mobile device is associated with at least one family of mobile devices in the hierarchical organization of information;
identify one or more strings from a stream of information associated with a mobile device;
recognize the mobile device by comparing the one or more strings in the stream of information with corresponding strings in the hierarchical database;
select an entry in the hierarchical database wherein the entry includes characteristics compatible with the mobile device based on the recognition; and
generate information on the mobile device according to the characteristics selected from the entry in the hierarchical database.
